(19) United States
(12) Patent Application Publication
(10) Pub. No.: US 2026/0365462 A1
(43) Pub. Date: Nov. 19, 2026

(54) WORK TOOL, CARGO UNLOADING SUPPORT DEVICE, AND CARGO UNLOADING AUTOMATION EQUIPMENT AND METHOD

(71) Applicant: CJ LOGISTICS CORPORATION, Seoul (KR)

(72) Inventors: Seung Mo KIM, Seoul (KR); Dong-Seob LEE, Seoul (KR); Bo Kun PARK, Seoul (KR); Chul Joo YOON, Seoul (KR)

(73) Assignee: CJ LOGISTICS CORPORATION, Seoul (KR)

(21) Appl. No.: 19/136,509

(22) PCT Filed: Dec. 11, 2023
(86) PCT No.: PCT/KR2023/020355

§ 371 Date: Jun. 6, 2025

(30) Foreign Application Priority Data
Dec. 20, 2022 (KR) 10-2022-0179864

(51) Int. Cl. B65G 67/24; B25J 1/04; B25J 15/06; B25J 19/00

(52) U.S. Cl. CPC B65G 67/24; B25J 1/04; B25J 15/0616; B25J 19/002

(57) ABSTRACT

A work tool including a tool body formed to extend long in the longitudinal direction, and an adsorption part formed on one end of the tool body so as to adsorb the loaded cargo, wherein the adsorption part may include a plurality of suction cups, which are formed on an adsorption surface that comes into contact with surface of the loaded cargo, and are open toward the loaded cargo. A cargo unloading support device includes a work tool, which comes into contact with the loaded cargo so as to apply an external force for moving the loaded cargo, and a weight compensation device for compensating for weight of the work tool so as to reduce a workload of the operator, wherein the weight compensation device may include a wire for suspending the work tool and a pulley device for applying tension to the wire.

### TECHNICAL FIELD

The present disclosure relates to a work tool for supporting unloading of loaded cargo, a cargo unloading support device, cargo unloading automation equipment with the cargo unloading support device, and a method thereof. Particularly, the present disclosure relates to a work tool capable of providing excellent adsorption performance for loaded cargo, a cargo unloading support device including a weight compensation device for compensating weight of the work tool handled by an operator who assists in cargo unloading operations so as to reduce a workload, cargo unloading automation equipment including this cargo unloading support device, and a method thereof.

### BACKGROUND ART

In local and international delivery logistics, most technologies for automatically unloading cargo from cargo areas of vehicles have limitations depending on physical properties of the cargo that can be handled. Also, it is difficult to sort and transfer cargo discharged in bulk units to subsequent processes, and there are limitations to general-purpose applications due to installation space issues and level differences between the vehicle cargo areas and docks. In addition, such technologies are not suitable for applications to the domestic delivery logistics environments due to inability for connection with conveyors provided in existing logistics terminals, increased construction costs due to layout changes, high construction costs of robot systems, or the like.

For example, robotic arm-based unloading automation techniques have problems in that size and type of cargo that can be unloaded are determined depending on the location and handling characteristics of the cargo and there are no cargo sorting and transfer functions, resulting in many restrictions on connection with subsequent processes.

### DISCLOSURE OF INVENTION

### Technical Problem

The problem that the present disclosure aims to solve is to support automation of unloading process by automatically unloading cargo loaded in a vehicle cargo area.

The present disclosure is also intended to provide a tool and an automation apparatus, which can be flexibly applied to the construction of automation lines in connection with existing infrastructure and subsequent processes to suit the purpose of operation in the delivery logistics industry, especially in the delivery logistics terminal environments.

In addition, the present disclosure is intended to provide a tool and an automation apparatus, which can replace existing human-dependent work with automation-based process technology when unloading cargo at logistics terminals, etc., thereby reducing labor costs, easing labor intensity in the unloading process, and improving work productivity.

The present disclosure is also intended to provide a tool and an automation apparatus, which can reflect the purpose of unloading, cargo characteristics, etc., in order to overcome limitations on cargo handling, lack of dock spaces and high infrastructure change costs, and to adapt to local delivery logistics environments.

The technical challenges of the present disclosure are not limited to the technical problems mentioned above, and other technical problems not mentioned will be clearly understood by those skilled in the art from the description hereinafter.

### Solution to Problem

According to an embodiment of the present disclosure to solve the above problems, a work tool comes into contact with loaded cargo so as to apply an external force for moving the loaded cargo to the loaded cargo and may include a tool body formed to extend long in the longitudinal direction, and an adsorption part formed on one end of the tool body so as to adsorb the loaded cargo, wherein the adsorption part may include a plurality of suction cups, which are formed on an adsorption surface that comes into contact with surface of the loaded cargo, and are open toward the loaded cargo.

In one or more embodiments, the work tool may further include a corrugated tubular joint for connecting the tool body and the adsorption part between the tool body and the adsorption part, wherein a vacuum passage communicating with the adsorption part may be formed to extend inside the corrugated tubular joint and the tool body. Compared to using a single (relatively large-sized) suction cup, by using the plurality of (relatively small-sized) suction cups and the corrugated tubular joint, there is an advantage in that excellent adsorption performance can be achieved for products of various shapes regardless of their shape characteristics.

According to an embodiment of the present disclosure to solve the above problems, a cargo unloading support device, may include a work tool, which is handled by an operator and comes into contact with loaded cargo so as to apply an external force for moving the loaded cargo to the loaded cargo, and a weight compensation device for compensating for weight of the work tool so as to reduce a workload of the operator, wherein the weight compensation device includes a wire for suspending the work tool and a pulley device for applying tension to the wire.

In one or more embodiments, the pulley device may be a composite pulley device that includes a fixed pulley around which the wire is wound, a movable pulley, and a weight element for generating tension.

In one or more embodiments, the weight element may have weight such that the tension of the weight element is equal to the weight of the work tool.

In one or more embodiments, one end of the wire may be connected to the work tool, the fixed pulley may include a first fixed pulley and a second fixed pulley, the movable pulley may include a first movable pulley, the wire may extend from one end to the other end by sequentially passing the first fixed pulley, the first movable pulley, and the second fixed pulley, the other end may be fixed to the first movable pulley, and the weight element may be fixed to the first movable pulley.

In one or more embodiments, the first fixed pulley and the second fixed pulley may be formed as a single pulley having two grooves, the two grooves may include a first groove and a second groove, and the wire extends from one end to the other end by sequentially passing the first groove of the single pulley, the first movable pulley, and the second groove of the single pulley.

In one or more embodiments, the weight element has weight three times the weight of the work tool, so that the tension of the weight element offsets the weight of the work tool.

In one or more embodiments, the cargo unloading support device may further include a guide arm for supporting the wire, wherein the wire may extend from one end to the other end by sequentially passing the guide arm and the weight compensation device.

In one or more embodiments, the guide arm may include an arm body having one end portion and the other end portion, and a first joint which supports the arm body so that the arm body can rotate horizontally at a position adjacent to the other end of the arm body, wherein the wire may extend from one end of the wire to the other end of the wire by sequentially passing one end portion of the arm body, the other end portion of the arm body, and the weight compensation device.

In one or more embodiments, the arm body may include a first part including the other end portion and a second part including the one end portion, and the guide arm may further include a second joint for coupling the second part to the first part so that the second part can horizontally rotate, thereby allowing two-stage horizontal rotation of the one end portion of the arm body.

In one or more embodiments, the arm body may have an initial standby position, and the guide arm may include an air suspension and/or spring that resists the horizontal rotation of the arm body away from the initial standby position.

In one or more embodiments, the guide arm may include a plurality of guide pulleys positioned adjacent to the one end portion of the arm body, and the wire may be guided while being commonly inscribed on adjacent guide pulleys among the plurality of guide pulleys.

In one or more embodiments, the work tool may include a tool body formed to extend long in the longitudinal direction, and an adsorption part formed on one end of the tool body so as to adsorb the loaded cargo.

In one or more embodiments, the adsorption part may include a plurality of suction cups, which are formed on an adsorption surface that comes into contact with surface of the loaded cargo and are open toward the loaded cargo.

In one or more embodiments, the work tool may further include a corrugated tubular joint for connecting the tool body and the adsorption part between the tool body and the adsorption part, and a vacuum passage communicating with the adsorption part may be formed to extend inside the corrugated tubular joint and the tool body.

In one or more embodiments, the work tool may further include wings that can hook and pull the loaded cargo.

In one or more embodiments, the work tool may further include a spring that applies a force to maintain the wings in a folded state and/or in an unfolded state.

In one or more embodiments, the work tool may further include a wire hook, into which the tool body is inserted so as to rotate relatively and to which the one end of the wire is fixed.

In one or more embodiments, the work tool may further include a handle part that can be held by an operator, and the handle part may be coupled to the tool body such that the handle part can rotate 360° in a circumferential direction of the tool body.

In one or more embodiments, the work tool may include two handle parts that an operator holds in each hand, and the two handle parts may be coupled to the tool body so as to be spaced apart from each other in the longitudinal direction of the tool body, and a separation distance between the two handle parts can be adjusted.

According to an embodiment of the present disclosure to solve the above problems, a cargo unloading automation equipment may include a digging hopper, and a cargo unloading support device, wherein the digging hopper may include a digging plate for moving forward so as to be inserted between a bottom surface of a cargo area and a bottom surface of loaded cargo, and a transfer conveyor formed to extend backward from the digging plate, wherein the transfer conveyor may transfer the loaded cargo seated on a transfer surface of the transfer conveyor backward, as the digging plate moves forward and is inserted between the bottom surface of the cargo area and the bottom surface of the loaded cargo, and wherein the cargo unloading support device may include a work tool, which is handled by an operator and comes into contact with the loaded cargo so as to apply an external force for moving the loaded cargo to the loaded cargo, and a weight compensation device for compensating for weight of the work tool so as to reduce a workload of the operator, and the weight compensation device may include a wire for suspending the work tool and a pulley device for applying tension to the wire.

According to an embodiment of the present disclosure to solve the above problems, in a cargo unloading automation method for unloading loaded cargo by using cargo unloading automation equipment, which includes a digging hopper and a cargo unloading support device, wherein the digging hopper includes a digging plate for moving forward so as to be inserted between a bottom surface of a cargo area and a bottom surface of loaded cargo, and a transfer conveyor formed to extend backward from the digging plate, wherein the transfer conveyor transfers the loaded cargo seated on a transfer surface of the transfer conveyor backward, as the digging plate moves forward and is inserted between the bottom surface of the cargo area and the bottom surface of the loaded cargo, and wherein the cargo unloading support device includes a work tool, which is handled by an operator and comes into contact with the loaded cargo so as to apply an external force for moving the loaded cargo to the loaded cargo, and a weight compensation device for compensating for weight of the work tool so as to reduce a workload of the operator, and the weight compensation device includes a wire for suspending the work tool and a pulley device for applying tension to the wire, the method may include moving the digging hopper forward until the digging plate is inserted between the bottom surface of the cargo area and the lower surface of the loaded cargo, and carrying out individual position movement while automatically transferring the loaded cargo seated on the transfer surface of the transfer conveyor backward, as the digging hopper moves forward so that the digging plate is inserted between the bottom surface of the cargo area and the lower surface of the loaded cargo, in which in order to support the automatic transfer, an operator applies external force to at least parts of the loaded cargo by using the work tool so that the individual position movement is performed from a first position to a displaced second position.

The configuration and function of each of these solutions will become more apparent from the detailed contents for implementing the present disclosure described hereinafter based on the accompanying drawings.

### Advantageous Effects of Invention

According to the present disclosure, cargo unloading automation equipment, can be flexibly applied to the construction of automated lines in connection with subsequent processes and existing infrastructure to suit the purpose of operation in the logistics industry, especially, in the delivery logistics terminal environment, and can replace work that relies on human resources with automation-based process technology, thereby advantageously saving labor costs, reducing labor intensity in the unloading process and improving work productivity.

In addition, the present invention can overcome the disadvantages of the prior art, such as limitations in cargo handling, lack of dock spaces, and high infrastructure change costs, and have the advantage of high practicality since it can reflect the purpose of unloading, cargo characteristics or the like so as to adapt to local delivery logistics environments. For example, it can be contrasted with the robotic arm-based unloading automation techniques, which has many limitations in connection with subsequent processes in that size and type of cargo that can be unloaded are determined depending on the location and handling characteristics of the cargo and there are no cargo sorting and transfer functions.

Furthermore, according to the present disclosure, cargo can be unloaded individually using a suction-type picking stick, which is an operator assistance tool, or cargo can be handled individually according to packaging materials, loading conditions, and positions, thereby minimizing the impact on the physical characteristics of the cargo.

Moreover, according to the present disclosure, unloading process can be systemized in conjunction with telescopic conveyors in operation and directly connected to subsequent processes through design in consideration of compatibility with existing infrastructure, thereby exhibiting high usability in the delivery logistics environment and significantly contributing to the spread of unloading automation in the logistics industry.

The effect of present disclosure is not limited to the advantages mentioned above, and other advantages not mentioned will be clearly understood by those skilled in the art from the claims.

### BRIEF DESCRIPTION OF DRAWINGS

FIG. 1 is a view schematically showing cargo unloading automation equipment according to an embodiment of the present disclosure.

FIG. 2 is a view schematically showing a work tool according to an embodiment of the present disclosure.

FIG. 3 is a view schematically showing a guide arm according to an embodiment of the present disclosure.

FIG. 4 is a view schematically showing coupling relationship between a guide arm and a work tool according to an embodiment of the present disclosure.

FIG. 5 and FIG. 6 respectively show an air suspension and spring of a guide arm according to an embodiment of the present disclosure.

FIG. 7 is a view schematically showing a weight compensation device according to an embodiment of the present disclosure, and

FIG. 8 is a view schematically showing a weight compensation device according to an embodiment of the present disclosure.

### BEST MODE FOR CARRYING OUT THE INVENTION

The features and advantages of the present disclosure and methods for achieving them will become more apparent by referring to the embodiments described in detail below along with the accompanying drawings. However, the present disclosure is not limited to the embodiments disclosed below and will be implemented in various different forms. These embodiments are merely provided to fully inform those skilled in the art of the scope of the present disclosure, and the present disclosure is defined by the claims. Like reference numerals refer to like elements throughout the description.

It will be understood that when an element is referred to as being “connected to” or “coupled to” another element, it may be directly connected or coupled to the other element, or an intervening element may exist. In contrast, it will be understood that when an element is referred to as being “directly connected to” or “directly coupled to” another element, there is no intervening element. The expression “and/or” includes any combination of one or more of the items mentioned.

The terms used herein is intended to describe embodiments and are not intended to limit the present disclosure. Singular forms herein are intended to include plural forms unless the context clearly indicates otherwise. The terms “comprises,” and/or “comprising,” or the like used herein specify the presence of stated features, steps, operations, and/or elements but do not preclude the probability of presence or addition of one or more other features, steps, operations, and/or elements.

Terms, such as first and/or second, may be used to describe various elements, but the elements are not limited by these terms. The terms are used merely for the purpose of distinguishing one element from other elements. Therefore, of course, a first component mentioned below may also be a second component within the technical idea of present disclosure.

As used herein, terms related to direction such as “front,” “rear,” “left,” “right,” “vertical,” and “horizontal” are used in a relative sense for convenience of explanation, and may vary depending on the direction of observation.

Unless otherwise defined, all terms used herein, including technical or scientific terms, have the same meanings as terms generally understood by those of ordinary skill in the art to which the present disclosure pertains, Terms defined in a generally used dictionary are not interpreted to have ideal or excessively formal meanings unless clearly defined herein.

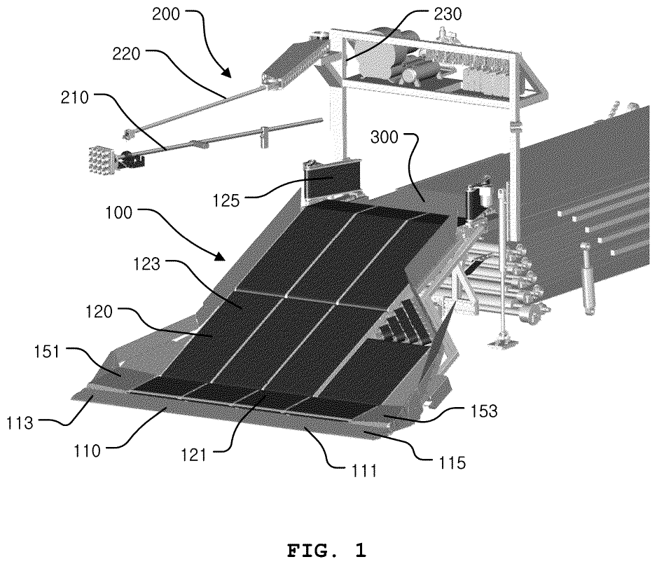

FIG. 1 is a view schematically showing cargo unloading automation equipment according to an embodiment of the present disclosure.

The cargo unloading automation equipment may include a digging hopper 100 and a cargo unloading support device 200.

The digging hopper 100, which automates unloading of loaded cargo, can be provided in front of a telescopic conveyor 300. The digging hopper 100 can be coupled to the telescopic conveyor 300 so as to move relative to the telescopic conveyor 300. Therefore, as the telescopic conveyor 300 extends, the digging hopper 100 can move forward.

The digging hopper 100 may include a digging plate 110 for moving forward so as to be inserted between a bottom surface of a vehicle cargo area and a lower surface of loaded cargo, and a transfer conveyor 120 formed to extend backward from the digging plate 110. As the digging plate 110 moves forward and is inserted between the bottom surface of the cargo area and the lower surface of the loaded cargo, the loaded cargo collapses and is automatically seated on a transfer surface of the transfer conveyor 120, so that the cargo placed on the transfer surface may be transferred backward by the transfer conveyor 120. Additionally, the cargo transferred backward by the transfer conveyor 120 can be continuously transferred to the telescopic conveyor 300 behind the transfer conveyor 120.

In one or more embodiments, the transfer conveyor 120 may include a pitching conveyor 121, an inclination transfer conveyor 123 and a link transfer conveyor 125.

The digging hopper 100 may include a vertical drive device for moving a front end of the digging hopper 100 up and down. Additionally, the digging hopper 100 may include a horizontal drive device for moving the digging hopper 100 left or right.

In one or more embodiments, the digging plate 110 may include a main plate 111, a first expansion plate 113, which is provided on a left side of the main plate 111 and is expandable in the left direction, and a second expansion plate 115, which is provided on a right side of the main plate 111 and is expandable in the right direction,

In addition, the digging hopper 100 may include a third expansion plate 151, which is provided on a left side of the transfer conveyor 120 and is expandable in the left direction, and a fourth expansion plate 153, which is provided on a right side of the transfer conveyor 120 and is expandable in the right direction.

The first expansion plate 113 and the second expansion plate 115 are driven by an expansion plate drive device, and the third expansion plate 151 and the fourth expansion plate 153 are configured to be interlocked with the first expansion plate 113 and the second expansion plate 115, respectively.

The cargo unloading support device 200 is a device that safely handles and supports unloading of cargo loaded in a vehicle cargo area by an individual unit. The cargo unloading support device 200 can support automation of cargo unloading performed by the digging hopper 100.

The cargo unloading support device 200 may include a work tool 210 that assists a process operator to handle loaded cargo individually or in bulk units. In addition, the cargo unloading support device 200 may include a weight compensation device 230 based on a composite pulley which can minimize weight loads of the cargo and the tool 210 so as to alleviate labor intensity. The work tool 210 may be connected to the weight compensation device 230 so that the weight of the work tool 210 can be compensated.

The work tool 210 is handled by an operator and comes into contact with loaded cargo so as to apply an external force for moving the loaded cargo to the loaded cargo. The weight compensation device 230 may compensate for weight of the work tool 210 so as to reduce a workload of an operator. A mechanical weight compensation device 230 may include a wire 231 for suspending the work tool 210 and a pulley device for applying tension to the wire 231.

In addition, the cargo unloading support device 200 may further include a guide arm 220 for supporting the wire 231 between the work tool 210 and the pulley device of the weight compensation device 230. Therefore, the wire 231 may extend from one end to the other end by sequentially passing the guide arm 220 and the weight compensation device 230. The guide arm 220 may be formed to extend long in the longitudinal direction so as to expand an operating radius of the work tool 210.

Furthermore, the present disclosure provides a cargo unloading automation method. According to an embodiment of the present disclosure, a cargo unloading automation method may include moving the digging hopper 110 forward until the digging plate 110 is inserted between the bottom surface of the cargo area and the lower surface of loaded cargo, and carrying out individual position movement while automatically transferring the loaded cargo seated on the transfer surface of the transfer conveyor 120 backward, as the digging plate 110 moves forward and is inserted between the bottom surface of the cargo area and the lower surface of the loaded cargo, in which in order to support automatic transfer, an operator applies an external force to at least parts of the loaded cargo by using the work tool 210 so that the individual position movement is performed from a first position to a displaced second position.

According to an embodiment of the present disclosure, using the work tool 210, which is an operator assistance tool, individual loaded products can be directly processed, and unloading can be automated in connection with subsequent processes. In particular, the work tool 210 can be applied to various vehicle cargo areas and to the delivery terminal unloading process with high labor intensity. For example, when a vehicle to be unloaded docks at an unloading dock in a delivery terminal, the telescopic conveyor 300 is extended in order to move the digging hopper 100 of the cargo unloading automation equipment according to an embodiment of the present invention to the front of a cargo area, and then unloading process can be started by sweeping loaded products into the hopper 100 by using the work tool 210 until a minimum entry space is secured inside the cargo area. In basic unloading process, items piled up at the top are handled with the work tool 210 in order to minimize product damage. As the digging hopper 100 moves forward, items in the middle and on the bottom are automatically discharged by the pitching conveyor 121 and the inclination transfer conveyor 123 of the digging hopper 100. The expansion plates 113, 115, 151, 153 may adhere to wall surfaces of the cargo area so as to ensure that no cargo remains on the left and right sides. In addition, the hopper 100 may be changed in position through up and down vertical operations and left and right horizontal operations, depending on conditions of the cargo or docking errors.

When pulling a load, an adsorption part 212 of the work tool 210 can be operated so as to directly pull the load. In particular, the weight compensation device 230 based on the composite pulley can be applied to minimize dynamic load of the work tool 210 and products to be handled, and a multi-joint guide arm 220 based on multiple pulleys is provided considering a motion range of the work tool 210 so as to handle loads in various positions, so that there are no restrictions on handling position and labor intensity can be reduced during operation.

According to an embodiment of the present disclosure, the cargo unloading support device 200 based on automatic load discharge can alleviate the labor intensity of unloading operators in a delivery terminal and has high productivity per worker, compared to the existing manual unloading system. Therefore, the device 200 is expected to be highly useful in a delivery logistics environment where the supply and demand of manpower is not smooth.

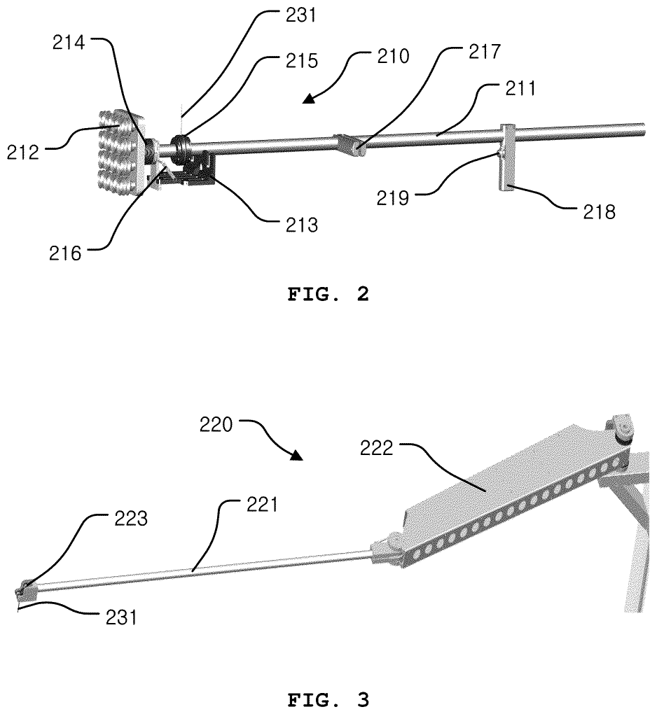

FIG. 2 is a view schematically showing a work tool 210 according to an embodiment of the present disclosure.

During automatic unloading, in order to directly handle loaded cargo to prevent damage to products due to the impact of dropping, to prevent products from jamming left or right, or to organize products in bulk units, etc., a load handling picking stick, which is an adsorption technology-based unloading assistance device for operators, can be provided as a work tool 210. In addition, in order to handle loads where it is difficult to find a surface to adsorb or to handle loads quickly, hook-shaped wings 213 which are convenient for quickly handling loads are designed in a spring-based manual folding form, wherein the wings 213 can be unfolded when necessary, so as to handle loads without vacuum adsorption.

In order to ensure that the wire 231 has a constant force direction according to operation of the work tool 210 and has no restrictions on movement, a rotatable wire hook 215 can be applied to be coupled to the tool body 211 of the work tool 210. The work tool 210 has an appropriate length based on an operator position so as to avoid blind spots while handling loads, and can be made of carbon fiber so as to minimize labor intensity due to its own weight.

In one or more embodiments, the work tool 210 may include a tool body 211 formed to extend long in the longitudinal direction and an adsorption part 212 formed on one end of the tool body 211 so as to adsorb the loaded cargo. The tool body 211 may be formed in a stick shape, but the present disclosure is not limited thereto, In order to handle various types of products by vacuum adsorption, the adsorption part 212 may include a plurality of suction cups, and the plurality of suction cups may be formed on an adsorption surface that comes into contact with surface of the loaded cargo, and be open toward the loaded cargo. Additionally, the adsorption part 212 may include an air chamber that forms a vacuum area, and the air chamber can be designed to be as slim and lightweight as possible to suit the configuration of the suction cups. Compared to a single (relatively large-sized) suction cup, the plurality of (relatively small-sized) suction cups can provide excellent adsorption performance for products of various shapes regardless of their shape characteristics.

A connection portion between the air chamber of the adsorption part 212 and the tool body 211 must be switchable in all directions so that there are no restrictions in forming an adsorption surface of an object, and at the same time, there must be no hindrance to amount of air inflow. Therefore, the work tool 210 may include a corrugated tubular joint 214 for connecting the tool body 211 and the adsorption part 212. A vacuum passage is formed to extend inside the corrugated tubular joint 214 and the tool body 211, and can communicate with the adsorption part 212. The corrugated tubular joint 214 contributes to ensuring that the plurality of suction cups adhere well to different types of cargo, regardless of the shape characteristics of the cargo, thereby achieving excellent adsorption performance.

The work tool 210 may include the wings 213 that can hook and pull loaded cargo. Of course, the wings 213 can be used to push loaded cargo forward or to a side when necessary, and the present disclosure does not exclude such uses of the wings 213. When loaded cargo is not suitable for adsorption, the loaded cargo can be moved by hooking the wings 213 to the loaded cargo and pulling the wings 213 (sometimes pushing the wings 213 forward or to the side). Herein, the meaning of “hooking” does not mean a strong coupling relationship to an extent that the loaded cargo does not separate from the wings 213, but means a simple contact relationship more suitable for pulling or pushing forward or to the side. Herein, “more suitable” means that it is more effective to pull or push loaded cargo forward or to the side by using the wings 213 than to pull or push the loaded cargo forward or to the side only with, for example, the tool body 211 in a rod shape without the wings 213. In one or more embodiments, the wings 213 may be formed in a hook shape, but the present disclosure is not limited thereto.

The wings 213 are coupled to the tool body 211 so that the wings 213 can be converted from a folded state to an unfolded state and vice versa. When an operator wants to use the wings 213, it is necessary to convert the wings 213 to the unfolded state. The work tool 210 may include a spring 216 that applies a force to the wings 213 so as to maintain the wings 213 in the folded and/or unfolded state. Accordingly, the wings 213 are prevented from shaking in an unfixed state, in which the wings 213 are not fixed to the tool body 211 in the folded or unfolded state. FIG. 2 shows a state in which the wings 213 are folded by the force of the spring 216. In one or more embodiments, conversion between the folded state and the unfolded state may be carried out by an operator manually flipping the wings 213. For example, as shown in the embodiment of FIG. 2, when an operator flips the wings 213 clockwise, the wings 213 can be converted to the unfolded state.

The work tool 210 may include the wire hook 215 to which the one end of the wire 231 is fixed. The tool body 211 can be inserted into the wire book 215 such that the tool body 211 can rotate relatively. Therefore, the wire hook 215 can be rotated in the circumferential direction of the tool body 211 around the tool body 211 as its axis.

The work tool 210 may include handle parts 217, 218 that can be held by an operator. In one or more embodiments, the handle parts 217, 218 are coupled to the tool body 211 and can rotate 360° in the circumferential direction of the tool body 211 around the tool body 211, allowing an operator to use them with both hands. In some cases, the work tool 210 may include two handle parts 217, 218 that an operator holds in each hand. The two handle parts 217, 218 are coupled to the tool body 211 so as to be spaced apart from each other in the longitudinal direction of the tool body 211, and a separation distance between the two handle parts can be adjusted.

The handle parts 217, 218 may be provided with button-type switches 219 for turning suction function on/off is applied on gripping portions of the handle parts 217, 218 so that an operator can easily control adsorption.

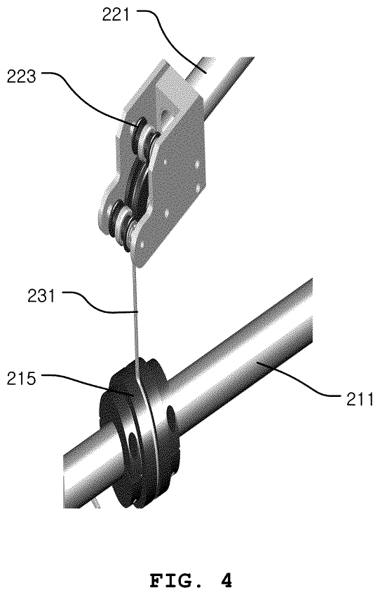

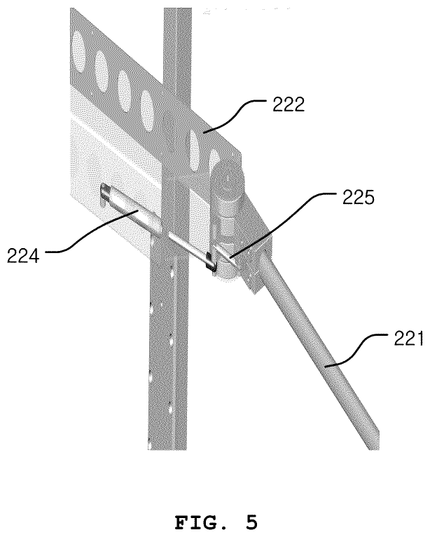

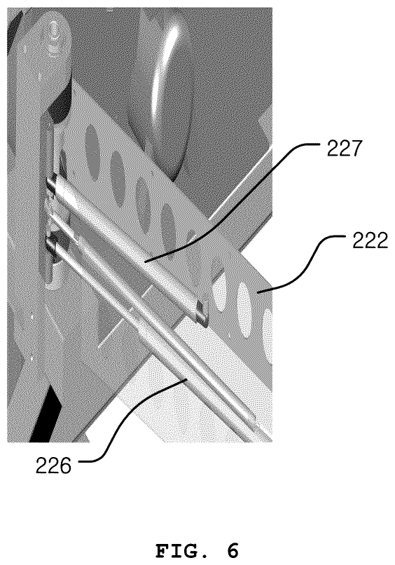

FIG. 3 is a view schematically showing a guide arm 220 according to an embodiment of the present disclosure, FIG. 4 is a view schematically showing coupling relationship between a guide arm 220 and a work tool 210 according to an embodiment of the present disclosure, and FIG. 5 and FIG. 6 respectively show an air suspension 224, 226 and a spring 225, 227 of a guide arm according to an embodiment of the present disclosure.

In one or more embodiments, the cargo unloading support device 200 may include the guide arm 220 that is flexible for left/right/up/down position movement so that an operator can handle stacked cargo in all directions within a cargo area when handling the cargo with the work tool 210. The guide arm 220 may be designed with a two-stage horizontal rotation joint structure, and the air suspension 224, 226 and the spring 225, 227 may be applied to each joint so as to reduce load and acceleration/deceleration when the work tool 210 moves horizontally to the left and right, thereby increasing flexibility.

In one or more embodiments, the guide arm 220 may include an arm body having one end portion and the other end portion. The arm body may be formed to extend long in the longitudinal direction, and length of the arm body may be designed in consideration of an appropriate working radius of the work tool 210. The arm body may include a first part 222 having the other end portion and a second part 221 having the one end portion. The guide arm 220 may include a first joint that horizontally and rotatably supports the arm body at a position adjacent to the other end portion of the arm body. Additionally, the guide arm 220 includes a second joint, which couples the second part to the first part so that the second part can horizontally rotate, thereby allowing two-stage horizontal rotation of the one end portion of the arm body. In these embodiments, the wire 231 may extend from the one end of the wire 231 to the other end of the wire 231 sequentially passing one end portion of the arm body, the other end portion of the arm body, and the weight compensation device 230. wherein the wire extends from the one end of the wire to the other end of the wire by sequentially passing the one end portion of the arm body, the other end portion of the arm body, and the weight compensation device.

The arm body has an initial standby position, and the air suspension 224, 226 and the spring 225, 227 resist the horizontal rotation of the arm body away from the initial standby position so that the arm body can return to the initial standby position. The initial standby position may be designed so that when the arm body of the guide arm 220 is positioned at the initial standby position, the work tool 210 supported by the guide arm 220 is positioned close to an operator. Therefore, even if the arm body deviates from the initial standby position as the operator applies force to the work tool 210 and moves the work tool 210 so as to handle cargo loaded at a position far from the operator, if the operator releases the work tool 210 or stops applying force to the work tool 210, the arm body returns to the initial standby position, and accordingly the work tool 210 can return to a position close to the operator.

The guide arm 220 may include a plurality of guide pulleys 223 positioned adjacent to the one end portion of the arm body so that the wire 231 connected to the work tool 210 can be applied with force in the vertical direction. The pulleys may have a structure, in which two or more pulleys are positioned facing each other up and down and can rotate in opposite directions, thereby preventing the wire 231 from being separated and allowing force to be transmitted in one direction. The wire may be guided so as to be commonly inscribed on adjacent guide pulleys among the plurality of guide pulleys 223.

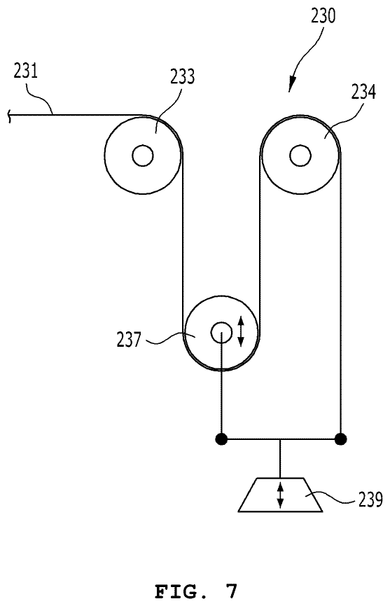

FIG. 7 is a view schematically showing a weight compensation device 230 according to an embodiment of the present disclosure.

The weight compensation device 230 can be designed with a composite pulley structure with a movable pulley and a fixed pulley for the purpose of eliminating the own weight of the work tool 210 and minimizing weight load, so that an operator can operate the work tool 210 for a long time.

In one or more embodiments, a pulley device is a composite pulley device that includes a fixed pulley around which the wire 231 is wound, a movable pulley, and a weight element 239 for applying tension to the wire, as shown in FIG. 7. The weight element 239 may have a weight such that the tension generated by the weight element 239 offsets the weight of the work tool 210.

The composite pulley device may be configured so that the wire 231 passing through the fixed pulley positioned adjacent to the other end portion of the guide arm 220 can move downward and then pass through the movable pulley that moves up and down. In addition, the composite pulley device may be designed so that weight is provided on an end of the wire 231 of the composite pulley device, wherein the weight is N times a weight of the work tool 210 on the basis of force that decreases according to the pulley structure.

In one or more embodiments, one end of the wire 231 may be connected to the work tool 210, the fixed pulley may include a first fixed pulley 233 and a second fixed pulley 234, and the movable pulley may include a first movable pulley. The wire 231 may extend from the one end to the other end by sequentially passing the first fixed pulley 233, the first movable pulley 237, and the second fixed pulley 234, the other end may be fixed to the first movable pulley 237, and the weight element 239 may be fixed to the first movable pulley.

In this structure, weight of the weight element can be designed to be three times the own weight of the work tool 210 so that the tension applied to the wire is the same as the weight of the work tool 210.

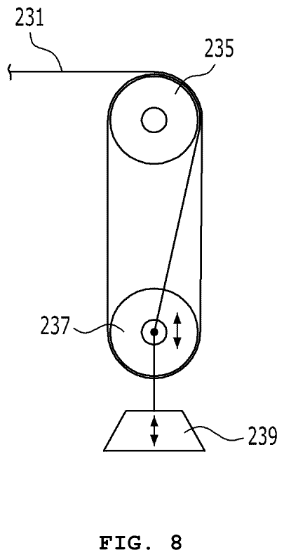

FIG. 8 is a view schematically showing a weight compensation device 230 according to an embodiment of the present disclosure.

In one or more embodiments, such as the embodiment as shown in FIG. 7, the first fixed pulley 233 and the second fixed pulley 234 may be formed as a single pulley 235 having two grooves. The two grooves include a first groove and a second groove, and a wire 231 may extend from one end to the other end by sequentially passing the first groove of the single pulley 235, the first movable pulley 237, and the second groove of the single pulley 235.

The embodiment of FIG. 8 can be said to be a modification of the embodiment of FIG. 7.

FIG. 7 and FIG. 8, show the embodiments using two fixed pulleys and one movable pulley (the embodiment of FIG. 8 can also be considered substantially equivalent to using two pulleys), but the present disclosure is not limited hereto, and a more diverse number of pulleys can be used. In addition, arrangement structure of the plurality of pulleys is not limited to the embodiments of FIG. 7 and FIG. 8, and more diverse arrangement structures may be provided.

By using this structure, the pulley device can be provided within a small installation space, and an operator can move the work tool N times the moving distance of the weight element, which has the advantage of providing a wide work radius.

As described hereinabove, according to present disclosure, it is possible to support unloading of cargo stored in a vehicle cargo arca in a logistics terminal by using the work took 210. In particular, delivery items can be handled universally depending the characteristics (size, packaging materials, conditions, etc.) thereof. In addition, it is possible to save investment costs in logistics facilities and reduce the labor intensity of unloading operators through flexible applications to existing infrastructure conveyors, dock environments, etc.

In addition, the present disclosure can support stable and continuous work when unloading cargo from above, by using a special tool with an adsorption function so that unloading workers can handle delivery parcels with various physical properties. Therefore, it is possible to handle and unload delivery cargo of various physical properties loaded in a cargo area according to delivery logistics environment without major restrictions. In addition, unloading operators can handle cargo individually by using an adsorption type work support tool, thereby ensuring flexibility in mechanical unloading operation.

The present disclosure is also designed to be linked with infrastructure facilities within the existing logistics terminal, allowing safe transfer to subsequent processes.

This type of unloading automation technology of safely handling cargo within a vehicle cargo area, based on the operator unloading support device 200 as described in the present disclosure, has never been used in the domestic logistics industry, especially in the unloading process at delivery terminals or loading/unloading process in general logistics centers. Therefore, the present disclosure can be said to be a new concept of unloading automation system that is differentiated from conventional technologies such as robot arm-based unloading automation systems and cargo area-fixed type special conveyor systems.

1. A work tool to be used by an operator to support unloading of loaded cargo,
the work tool coming into contact with loaded cargo so as to apply an external force for moving the loaded cargo to the loaded cargo, and the work tool comprising:
a tool body formed to extend long in the longitudinal direction; and
an adsorption part formed on one end of the tool body so as to adsorb the loaded cargo,
wherein the adsorption part includes a plurality of suction cups formed on an adsorption surface that comes into contact with surface of the loaded cargo, and
the plurality of suction cups are open toward the loaded cargo.

2. The work tool according to claim 1, further comprising
a corrugated tubular joint for connecting the tool body and the adsorption part between the tool body and the adsorption part, wherein a vacuum passage communicating with the adsorption part is formed to extend inside the corrugated tubular joint and the tool body.

3. A cargo unloading support device, comprising:
a work tool, which is handled by an operator and comes into contact with loaded cargo so as to apply an external force for moving the loaded cargo to the loaded cargo; and
a weight compensation device for compensating for weight of the work tool so as to reduce a workload of the operator,
wherein the weight compensation device includes a wire for suspending the work tool and a pulley device for applying tension to the wire.

4. The cargo unloading support device according to claim 3, wherein the pulley device is a composite pulley device that includes a fixed pulley around which the wire is wound, a movable pulley, and a weight element for generating tension.

5. The cargo unloading support device according to claim 4, wherein the weight element has weight so that the tension of the weight element offsets the weight of the work tool.

6. The cargo unloading support device according to claim 4, wherein one end of the wire is connected to the work tool,
the fixed pulley includes a first fixed pulley and a second fixed pulley, the movable pulley includes a first movable pulley,
the wire extends from one end to the other end by sequentially passing the first fixed pulley, the first movable pulley, and the second fixed pulley,
the other end is fixed to the first movable pulley, and
the weight element is fixed to the first movable pulley.

7. The cargo unloading support device according to claim 6, wherein the first fixed pulley and the second fixed pulley are formed as a single pulley having two grooves, the two grooves include a first groove and a second groove, and the wire extends from one end to the other end by sequentially passing the first groove of the single pulley, the first movable pulley, and the second groove of the single pulley.

8. The cargo unloading support device according to claim 6, wherein the weight element has weight three times the weight of the work tool, so that the tension of the weight element offsets the weight of the work tool.

9. The cargo unloading support device according to claim 3, further comprising a guide arm for supporting the wire, wherein the wire extends from one end to the other end by sequentially passing the guide arm and the weight compensation device.

10. The cargo unloading support device according to claim 9, wherein the guide arm includes:
an arm body having one end portion and the other end portion; and
a first joint which supports the arm body so that the arm body can rotate horizontally at a position adjacent to the other end of the arm body,
wherein the wire extends from one end of the wire to the other end of the wire by sequentially passing one end portion of the arm body, the other end portion of the arm body, and the weight compensation device.

11. The cargo unloading support device according to claim 10, wherein
the arm body includes a first part including the other end portion and a second part including the one end portion, and
the guide arm further includes a second joint for coupling the second part to the first part so that the second part can horizontally rotate, thereby allowing two-stage horizontal rotation of the one end portion of the arm body.

12. The cargo unloading support device according to claim 10, wherein
the arm body has an initial standby position, and
the guide arm includes an air suspension and/or spring that resists the horizontal rotation of the arm body away from the initial standby position.

13. The cargo unloading support device according to claim 10, wherein
the guide arm includes a plurality of guide pulleys positioned adjacent to the one end portion of the arm body, and
the wire is guided while being commonly inscribed on adjacent guide pulleys among the plurality of guide pulleys.

14. The cargo unloading support device according to claim 3, wherein the work tool includes:
a tool body formed to extend long in the longitudinal direction; and
an adsorption part formed on one end of the tool body so as to adsorb the loaded cargo.

15. The cargo unloading support device according to claim 14, wherein
the adsorption part includes a plurality of suction cups formed on an adsorption surface that comes into contact with surface of the loaded cargo, and
the plurality of suction cups are open toward the loaded cargo.

16. The cargo unloading support device according to claim 14, wherein
the work tool further includes a corrugated tubular joint for connecting the tool body and the adsorption part between the tool body and the adsorption part, and
a vacuum passage communicating with the adsorption part is formed to extend inside the corrugated tubular joint and the tool body.

17. The cargo unloading support device according to claim 14, wherein the work tool further includes wings that can hook and pull the loaded cargo.

18. The cargo unloading support device according to claim 17, wherein the work tool further includes a spring that applies a force to maintain the wings in a folded state and/or in an unfolded state.

19. The cargo unloading support device according to claim 14, wherein
the work tool further includes a wire hook to which the one end of the wire is fixed, and
the tool body is inserted into the wire hook so as to rotate relatively.

20. The cargo unloading support device according to claim 14, wherein
the work tool further includes a handle part that can be held by an operator, and
the handle part is coupled to the tool body such that the handle part can rotate in a circumferential direction of the tool body.

21. The cargo unloading support device according to claim 14, wherein
the work tool includes two handle parts that an operator holds in each hand, and
the two handle parts are coupled to the tool body so as to be spaced apart from each other in the longitudinal direction of the tool body, and
a separation distance between the two handle parts can be adjusted.

22. A cargo unloading automation equipment, comprising;
a digging hopper; and
a cargo unloading support device,
wherein the digging hopper includes
a digging plate for moving forward so as to be inserted between a bottom surface of a cargo area and a bottom surface of loaded cargo, and
a transfer conveyor formed to extend backward from the digging plate,
wherein the transfer conveyor transfers the loaded cargo seated on a transfer surface of the transfer conveyor backward, as the digging plate moves forward and is inserted between the bottom surface of the cargo area and the bottom surface of the loaded cargo, and
wherein the cargo unloading support device includes
a work tool, which is handled by an operator and comes into contact with the loaded cargo so as to apply an external force for moving the loaded cargo to the loaded cargo, and
a weight compensation device for compensating for weight of the work tool so as to reduce a workload of the operator, and
the weight compensation device includes a wire for suspending the work tool and a pulley device for applying tension to the wire.

23. A cargo unloading automation method for unloading loaded cargo by using cargo unloading automation equipment, which includes
a digging hopper and
a cargo unloading support device,
wherein the digging hopper includes
a digging plate for moving forward so as to be inserted between a bottom surface of a cargo area and a bottom surface of loaded cargo, and
a transfer conveyor formed to extend backward from the digging plate,
wherein the transfer conveyor transfers the loaded cargo seated on a transfer surface of the transfer conveyor backward, as the digging plate moves forward and is inserted between the bottom surface of the cargo area and the bottom surface of the loaded cargo, and
wherein the cargo unloading support device includes
a work tool, which is handled by an operator and comes into contact with the loaded cargo so as to apply an external force for moving the loaded cargo to the loaded cargo, and
a weight compensation device for compensating for weight of the work tool so as to reduce a workload of the operator, and
the weight compensation device includes a wire for suspending the work tool and a pulley device for applying tension to the wire,
the method comprising:
moving the digging hopper forward until the digging plate is inserted between the bottom surface of the cargo area and the lower surface of the loaded cargo; and
carrying out individual position movement while automatically transferring the loaded cargo seated on the transfer surface of the transfer conveyor backward, as the digging hopper moves forward so that the digging plate is inserted between the bottom surface of the cargo area and the lower surface of the loaded cargo, in which in order to support the automatic transfer, an operator applies external force to at least parts of the loaded cargo by using the work tool so that the individual position movement is performed from a first position to a displaced second position.
